(19) United States
(12) Patent Application Publication
(10) Pub. No.: US 2016/0236865 A1
(43) Pub. Date: Aug. 18, 2016

(54) Automated Warehouse Storage and Retrieval System

(71) Applicant: David Altemir, Carrollton, TX (US)

(72) Inventor: David Altemir, Carrollton, TX (US)

(21) Appl. No.: 15/045,110

(22) Filed: Feb. 16, 2016

Related U.S. Application Data
(60) Provisional application No. 62/116,605, filed on Feb. 16, 2015.

(51) Int. Cl. B65G 1/137; B65G 1/04

(52) U.S. Cl. CPC B65G 1/1373; B65G 1/0414; B65G 1/0421

(57) ABSTRACT

A system for the automated storage and retrieval of items in a warehouse which may be installed on current and existing warehouse shelving networks. One or more robotic arms are mounted on moving carriages which traverse the horizontal edge of select shelving systems along guideways mounted along said edges. The robotic arms may access the shelving units directly above and/or below the respective shelves of the robotic arms. An end effector located on the end of the robotic arm features a scanning device to accurately locate desired items based on the scanning of a barcode or other optical reading means. The end effector grabs the desired item, and the robotic arm system then transports the desired item to or from a picking station for delivery or storage, respectively. The system operates quickly and economically due to the inclusion of one or more robotic arms and the ability to operate on existing warehouse shelving networks.

### CROSS-REFERENCE TO RELATED APPLICATIONS

This application claims the benefit of provisional patent application, Ser. No. 62/116,605, filed Feb. 16, 2015, by the present inventor.

### TECHNICAL FIELD

The present invention relates to warehouse storage and retrieval systems and more particularly to a warehouse storage and retrieval system featuring a shelf-mounted robotic arm.

### BACKGROUND

Warehouses have long been used by manufacturers, wholesalers, distributers, and other like businesses as the central storage buildings of commercial goods. Historically, these warehouses were operated by individuals who manually loaded and unloaded goods to fill an order. As technology advanced, tasks previously performed by human workers could be performed by machines, and automated storage and retrieval systems were created.

Automated storage and retrieval systems operate on computer-controlled systems which can automatically place and retrieve items from storage locations defined in the system upon receiving an input command. Common examples of automated storage and retrieval systems in warehouses include vertical lift modules (VLMs), horizontal carousels, vertical carousels, A-frame dispensers and Cartesian coordinate warehouse systems.

Current automated storage and retrieval systems involve complex machinery with apparent limitations. Horizontal and vertical carousels, or “rotating shelving,” feature a series of bins which revolve around a track. As the alternative name implies, horizontal and vertical carousels rotate shelves of items around a track to be received by an individual at a set “pick point.” Although such a system allows individuals to retrieve items from a single location, such carousels are not conducive for storing and retrieving larger and heavier items due to the extreme forces such items would exert on the carousels.

VLMs utilize vertical lifts running along tracks between storage shelves and which extend from the warehouse floor to the ceiling. When an item is retrieved, the vertical lifts locate the appropriate storage bin, retrieve the item, and place the item on a track which carries the item to the pick point. However, due to the limited number of vertical lifts which can be placed on a single track—a single row of storage shelving—VLMs are limited in the amount of items which can be retrieved in a given period of time. Furthermore, VLMs require extensive construction to render the system operational, which limits the potential to use a shelving network which may already exist within a warehouse. The extensive amount of time required to construct such a system leads to lost profits, producing additional economic loss above the base cost of constructing the system.

Other widely-used automated systems include A-frame dispensers and Cartesian coordinate warehouse systems. A-frame systems feature two vertical channels which store items and are positioned over a conveyor belt which receives the desired items picked from the vertical channels by a picking module. Although systems utilizing A-frame automation are capable of retrieving a large amount of items in relatively short amounts of time, they are incapable of automatically storing items as the stock inventory must be hand-replenished by individual persons. Additionally, A-frame systems are limited to automation for smaller objects only, as A-frames can only accommodate items of a certain size in the vertical storage channels.

Warehouses which utilize a Cartesian coordinate warehouse system for automation feature an overhead gantry robot which retrieves and stores items throughout a warehouse. As the name suggests, this warehouse system operates on a Cartesian coordinate system wherein the position of the items on the warehouse floor corresponds to specific points on a Cartesian coordinate system. The gantry robot is positioned on the ceiling of the warehouse, mirroring the Cartesian coordinate system of the warehouse floor. When an item is retrieved, the gantry robot moves to the correct coordinates in the warehouse, lowers to the floor to grab the desired item, and moves the item to a retrieval station. While a Cartesian warehouse system is capable of automatically retrieving large items, Cartesian systems are limited to the retrieval of one item at a time since a Cartesian warehouse system utilizes the entire warehouse ceiling to accommodate one gantry robot. Additionally, Cartesian warehouse systems are unable to store items on shelving units due to the overhead nature of the single, gantry robot. Accordingly, a need exists for an automated storage and retrieval system which can retrieve multiple items—both large and small—in the shortest period of time.

### SUMMARY OF THE INVENTION

The present invention addresses the limitations of the prior art and features one or more shelf-mounted, robotic arms independently moving horizontally along a shelf-mounted guideway. The robotic arms are capable of independently storing and retrieving items, and transferring the items to a pick point where items can be received to fill an order or input. Additionally, the shelf-mounted robotic arms of the present invention are capable of storing and retrieving heavy loads in a relatively short amount of time due to the lift strength of the robotic arms and the one or more robotic arms mounted on the warehouse shelving units. Accordingly, the present system operates quickly and economically due to its speed in picking and transferring items, affordability of implementation in existing warehouses, and efficiency through multiple independent robotic arms operating simultaneously.

The present invention, which may be used with shelving networks already existing within a warehouse, consists of shelf-mounted robotic arms which move horizontally along shelf-mounted guideways. With the present invention, items may be stored and retrieved more quickly and economically due to one or more robotic arms operating independently to simultaneously store and retrieve items in the warehouse.

In the preferred embodiment, robotic arms are mounted on moving carriages which traverse horizontal guideways installed along the edge of the warehouse shelving system. These guideways may allow the robotic arms to move longitudinally within a warehouse shelving system. The robotic arms may access the shelving units directly above and/or below the respective shelves corresponding to the robotic arms. Once a command is received, the robotic arms independently move to an item of importance and transport the item to or from a picking station for retrieval or storage, respectively. Additionally, in the preferred embodiment, the present invention is compatible with and can be affordably retrofitted to shelving systems (“pallet racks”) that are commonplace in many modern warehouses. Therefore, the present invention can accommodate newly-constructed and pre-existing warehouses without significant interruption to business operations.

Through the independent operation of the multiple shelf-mounted robotic arms, storage and retrieval times can be minimized due to the ability to store and retrieve multiple items simultaneously. Additionally, the ability to utilize a shelving network currently existing in a warehouse minimizes the cost and time required to set up the present automated storage and retrieval system. Furthermore, multiple robotic arms confined to certain horizontal shelves maximize the amount of floor space in the warehouse, producing a safer working environment for individuals working among the multiple shelving units in the warehouse.

### BRIEF DESCRIPTION OF THE DRAWINGS

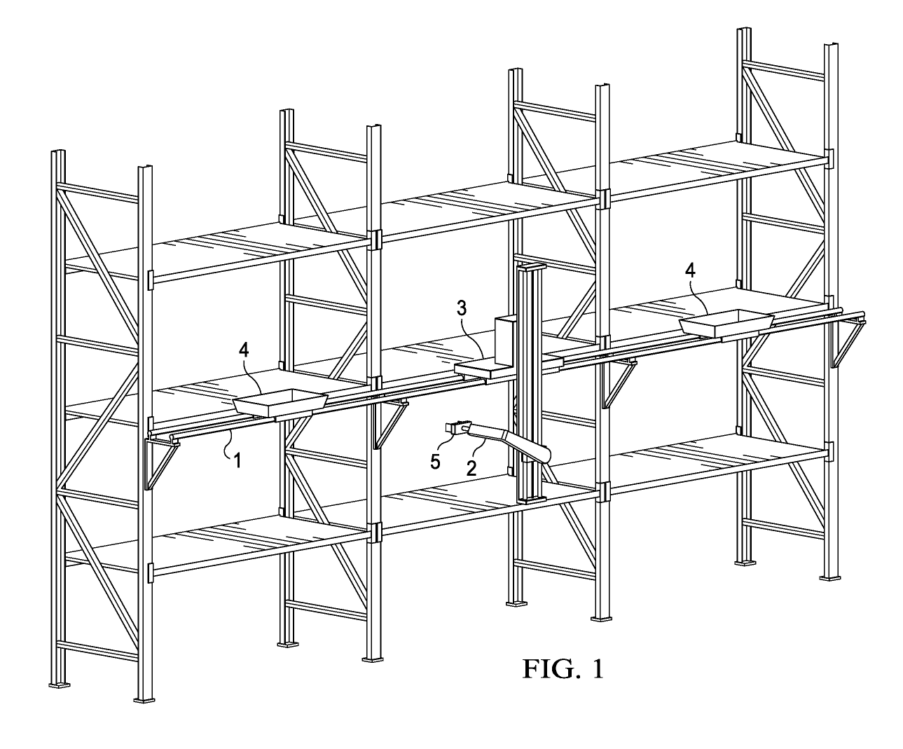

FIG. 1 is an automated warehouse storage and retrieval system embodying the principles of the present invention;
Ref 1 is a horizontal guideway;
Ref 2 is a selecting device;
Ref 3 is a moving carriage;
Ref 4 is a horizontally-movable picking tray;
Ref 5 is an end effector on a selecting device.

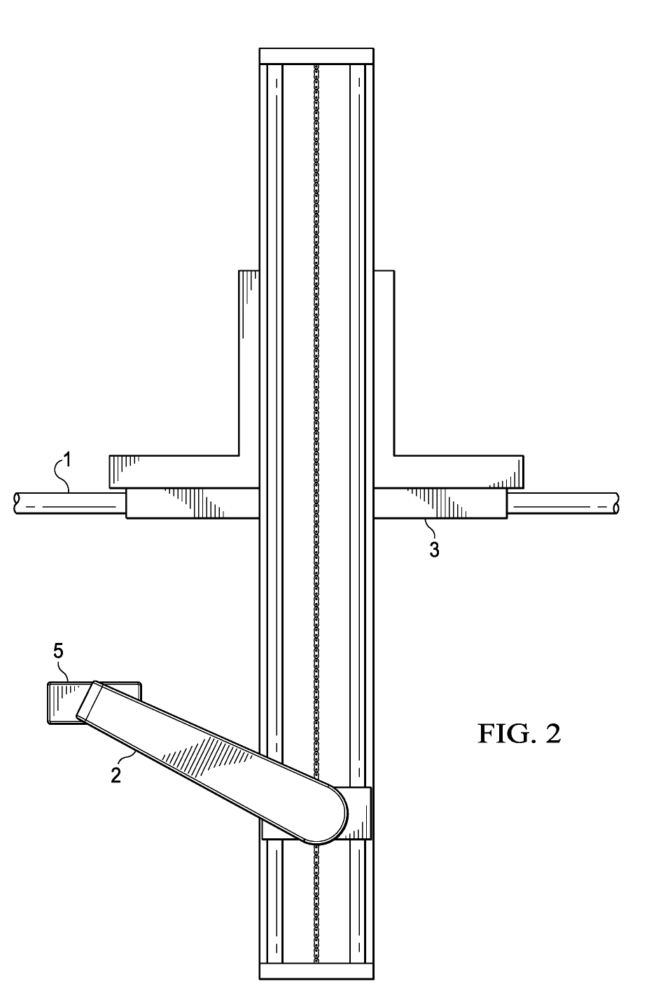

FIG. 2 is an automated warehouse storage and retrieval system embodying the principles of the present invention;
Ref 1 is a horizontal guideway;
Ref 2 is a selecting device;
Ref 3 is a moving carriage;
Ref 5 is an end effector on a selecting device.

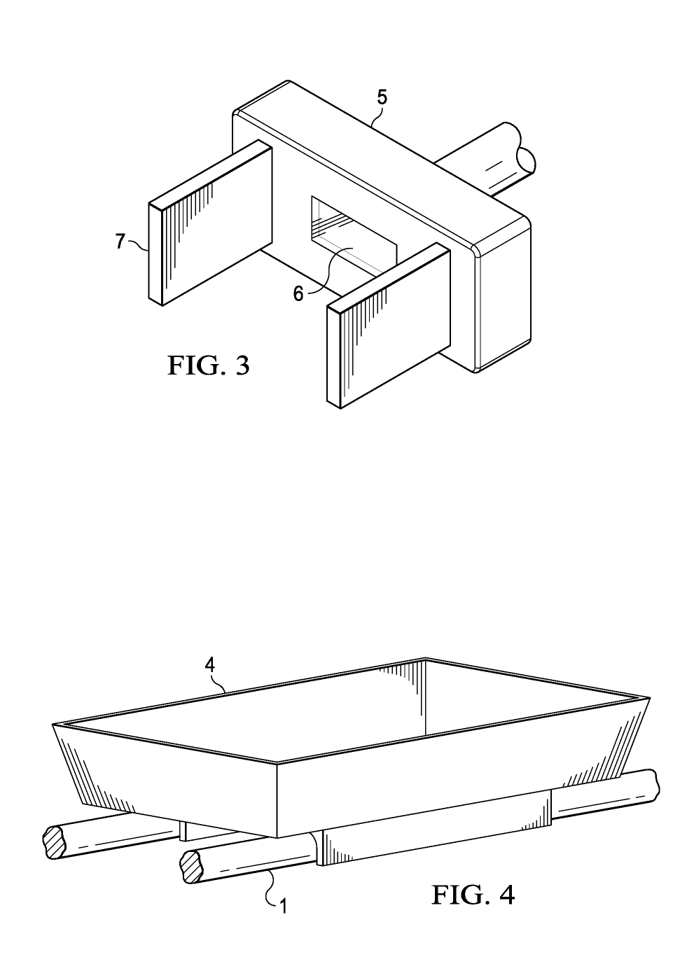

FIG. 3 is an end effector embodying the principles of the present invention;
Ref 5 is an end effector on a selecting device;
Ref 6 is a data-reading device on an end effector;
Ref 7 is a gripper on an end effector.

FIG. 4 is a horizontally-movable picking tray embodying the principles of the present invention;
Ref 1 is a horizontal guideway;
Ref 2 is a horizontally-movable picking tray.

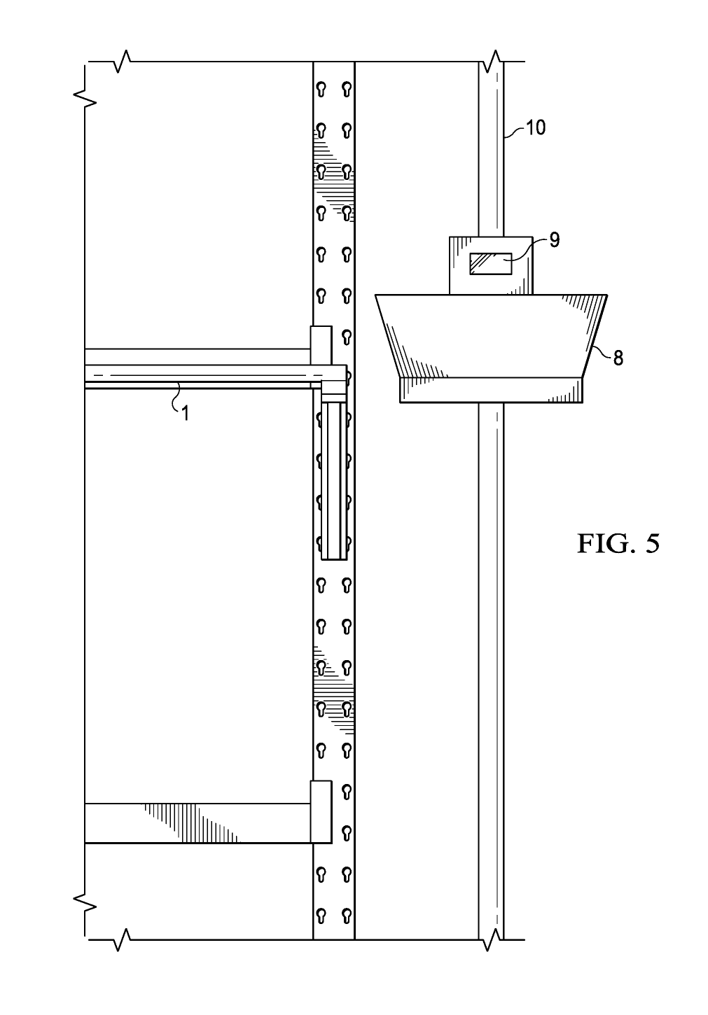

FIG. 5 is an automated warehouse storage and retrieval system embodying the principles of the present invention;
Ref 1 is a horizontal guideway;
Ref 8 is a vertically-movable picking station;
Ref 9 is a data-reading device on a vertically-movable picking station;
Ref 10 is a vertical guideway.

### DETAILED DESCRIPTION OF DRAWINGS

While the description herein is of the preferred embodiment of the present invention, it should be appreciated that the invention may be modified, altered, or varied without deviating from the scope and fair meaning of the following claims. Referring generally to the drawings, the present disclosure is an automated warehouse storage and retrieval system which features one or more robotic arms which operate independently to quickly and economically store and retrieve items from an existing warehouse shelving network.

FIG. 1 is the view of the preferred embodiment of a robotic arm configuration mounted on a warehouse shelving unit in the present automated warehouse storage and retrieval system. Additionally, FIG. 2 depicts an alternative view of the preferred embodiment of the robotic arm configuration in the present automated warehouse storage and retrieval system. In the preferred embodiment, a robotic arm 2 is mounted on a moving carriage 3 which transports the robotic arm 2 horizontally along a guideway 1 attached to a warehouse shelving system. In the preferred embodiment, the robotic arm 2 is a Selective Compliance Articulated Robot Arm (SCARA) or some other robotic arm assembly capable of manipulating heavy loads and being mounted on a moving carriage 3 on a shelf-mounted guideway 1. The guideway 1 may be any structure or device which mechanically constrains the robotic arm 2 configuration to travel linearly in one direction. In the preferred embodiment, the guideway 1 is mounted along the edge of a warehouse shelving system to allow the robotic arm 2 to access one or more shelving units above and/or below the shelf upon which the robotic arm 2 is constrained. A picking station at the end of the guideway 2 allows individuals to safely and quickly retrieve and store items in a single location.

In the preferred embodiment of the retrieval process, once the system receives an order requesting one or more products to be retrieved, the system notifies the robotic arm 2 configuration of the location of the desired item, as noted in the system's computerized inventory management system. Once the robotic arm 2 configuration is notified, the moving carriage 3 may transport the robotic arm 2 to the desired warehouse location. In the preferred embodiment, the end effector 5 on the robotic arm 2 utilizes barcode reading or some other form of optical object recognition to ensure that the desired item is, in fact, retrieved. In the preferred embodiment, once the desired item is located, the end effector 5 grabs the desired item and places it in a picking tray 4 which works in collaboration with the robotic arm 2 and transfers the item to the picking station. This picking process may be repeated until either all of the desired products have been retrieved or the picking tray 4 is full. In the preferred embodiment, the retrieved items will then be transferred to the picking station for retrieval of the item. The picking station may feature conveyor belts, lifts, or other transporting means to ensure the item reaches its final destination. In the preferred embodiment, once the item is successfully retrieved, a user may be notified that the item has been successfully retrieved via radio frequencies or other communication means. Once the item is retrieved by the user, the system will then await its next command from the computerized system.

In the preferred embodiment of the storage process, items may be manually scanned and placed on a conveyor belt, lift, or other transporting means to transfer the scanned item to the appropriate picking station based on the information received from the computerized inventory management system. The picking station may feature a sensor which activates when an item is placed in the picking station to notify the robotic arm 2 configuration that an item has been placed in the picking station at the end of the guideway 1. In the preferred embodiment, the end effector 5 on the robotic arm 2 scans the received item using barcode reading or some other form of optical object recognition to determine the appropriate location for storage on the warehouse shelving system. Once the item is successfully scanned, the end effector 5 may pick the item from the picking tray 4 for storage. This picking process may be repeated until all of the desired products have been retrieved. In the preferred embodiment, the retrieved items will then be transferred from the picking tray 4 to the appropriate location in the warehouse shelving system for shipping, use, or transfer.

In the preferred embodiment of the warehouse storage and retrieval system, the movable picking tray 4 system may be comprised of one or more picking trays 4 operating in concert with the robotic arm 2 configuration to quickly transfer items between robotic arms 2 and picking stations at one or both ends of the guideway 1. The work performed by the robotic arms 2, the movable picking trays 4, and any interconnected lifts or conveyors may all be coordinated to reduce overall storage, retrieval, and transfer cycle times.

What is claimed:

1. An automated warehouse storage and retrieval system, comprising:
at least one horizontal guideway configured to attach to a warehouse shelving unit;
at least one vertical guideway configured to attach to said warehouse shelving unit;
at least one horizontally-movable picking tray;
at least one moving carriage configured to attach to said horizontal guideway;
at least one selecting device configured to attach to said moving carriage; and,
at least one vertically-movable picking station.

2. The automated warehouse storage and retrieval system of claim 1, wherein said selecting device is selected from the group consisting of selective-compliance assembly robot arms, gantry robots, and six-axis robots.

3. The automated warehouse storage and retrieval system of claim 2, wherein said selecting device is further comprised of a data-reading device selected from the group consisting of barcode readers, quick response code readers, optical cameras, and radio frequency identification readers.

4. The automated warehouse storage and retrieval system of claim 1, wherein said vertically-movable picking station is further comprised of a data-reading device selected from the group consisting of barcode readers, quick response code readers, optical cameras, and radio frequency identification readers.

5. The automated warehouse storage and retrieval system of claim 1, wherein said horizontally-movable picking station attaches to and moves horizontally along said horizontal guideway.

6. The automated warehouse storage and retrieval system of claim 5, wherein said vertically-moving picking station attaches to and moves vertically along said vertical guideway.

7. A method for automated storage and retrieval of items in a warehouse, comprising:
receiving a picking order from a computerized system;
transmitting said picking order to one or more shelf-mounted moving carriages;
moving said shelf-mounted moving carriages to an item location to retrieve a desired item identified in said picking order;
positioning a selection device in front of said item location;
identifying said desired item on a warehouse shelving unit at said item location using a data-reading device affixed to said selection device to confirm location of said desired item;
retrieving said desired item using an end effector attached to said selection device;
depositing said desired item into a picking tray mounted on a horizontal guideway attached to said warehouse shelving unit;
moving said picking tray and said shelf-mounted moving carriage to an end of said warehouse shelving unit;
retrieving said desired item from said picking tray using said end effector attached to said selection device;
identifying said desired item using a data-reading device affixed to a picking station mounted on a vertical guideway to confirm retrieval of said desired item;
depositing said desired item into said picking station mounted on said vertical guideway attached to a warehouse shelving unit; and
moving said picking station to desired vertical location for ultimate retrieval by warehouse worker.

8. The method of claim 7, further comprising:
placing an item in said picking station;
moving said picking station to specified vertical location;
identifying said item using said data-reading device affixed to said selection device;
retrieving said item from said picking station using said end effector attached to said selection device;
depositing said item into said picking tray;
identifying said item using said data-reading device affixed to said selection device to confirm desired location for storage of said item;
moving said picking tray and said shelf-mounted moving carriage to a desired location on a warehouse shelving unit;
retrieving said item from said picking tray; and,
depositing said item into said desired location for storage of said item on warehouse shelving unit.

9. The method of claim 8, wherein said selection device is selected from the group consisting of selective-compliance assembly robot arms, gantry robots, and six-axis robots.

10. The method of claim 8, wherein said data-reading device is selected from the group consisting of barcode readers, quick response code readers, optical cameras, and radio frequency identification readers.
